(19) United States
(12) Patent Application Publication
(10) Pub. No.: US 2009/0230779 A1
(43) Pub. Date: Sep. 17, 2009

(54) CONTROL APPARATUS

(76) Inventors: Liam Anthony Ryan, Ardnacrusha (IE); Edward Joseph Edmonds, Limerick (IE); John Gerard Curran, Parteen (IE)

Correspondence Address: SUGHRUE MION, PLLC, 2100 PENNSYLVANIA AVENUE, N.W., SUITE 800, WASHINGTON, DC, 20037, US

(21) Appl. No.: 12/470,762

(22) Filed: May 22, 2009

Related U.S. Application Data
(63) Continuation of application No. 11/572,806, filed on Jan. 26, 2007, now abandoned.

(30) Foreign Application Priority Data
Sep. 2, 2004 (IE) S2004/0583

(51) Int. Cl. H01H 47/00

(52) U.S. Cl. 307/125

(57) ABSTRACT

Control apparatus (1) for selectively applying a mains AC electrical supply (3) to an electrical appliance (4) in response to a remote signal received via a cellular telecommunications network comprises a housing (8) within which an electrical socket (14) for providing power to the appliance (4) is integrally formed. An electrical plug top (10) on a cable (12) extending from the housing (8) is provided for coupling to the mains supply (3). A switch circuit (15) under the control of a microcontroller (19) controls the mains supply (3) to the electrical socket (14). A communications circuit (20) which is adapted for communicating with a cellular telecommunications network receives SMS control messages, and the microcontroller (19) is responsive to the SMS control messages for in turn operating the switch circuit (15) to selectively switch the mains supply (3) to the appliance (4). A power supply circuit (28) independent of the mains supply (3) powers the control apparatus (1). A volt meter (22) monitors the presence of the mains supply (3) and an amp meter (24) monitors the current being drawn by the appliance (4). The microcontroller (19) is responsive to the volt meter (22) detecting the mains supply and the amp meter (24) detecting the absence of current being drawn by the appliance (4) when the switch circuit (15) is in the closed circuit state for determining the operational status of the appliance as faulty.

This is a Continuation of application Ser. No. 11/572,806 filed Jan. 26, 2007, which is a national stage application filed under §371 of PCT Application No. PCT/IE2005/000090, published as WO2006/025041, filed Sep. 2, 2005, which claims benefit of Irish Patent Application No. S2004/0583 filed Sep. 2, 2004, the disclosures of which are incorporated herein by reference in their entirety.

### BACKGROUND OF THE INVENTION

The present invention relates to control apparatus, and in particular, to a control apparatus for selectively applying an electrical power supply to an electrical load in response to a remotely received signal.

There are many applications where it is desirable, and indeed, in many cases necessary, to be able to selectively apply an electrical power supply, for example, mains electricity, to an electrical load in response to a remotely generated signal. For example, it is desirable to be able to power up a central heating system in a holiday house a few days before one intends to arrive, in order to air the house, particularly if the house had been uninhabited for a lengthy period, for example, over the winter. Apparatus for applying power to such loads are known, and in general, are operable in response to a signal received on a land line of a telecommunications network.

Typically, such apparatus comprise a switch circuit for electrically coupling the electrical load to the mains electricity supply. The switch circuit is responsive to one signal received on a land line of a telecommunications network for applying the mains electricity supply to the electrical load, and the switch circuit is responsive to another signal also received via the land line of the telecommunications network for isolating the electrical load from the mains electricity supply. In general, such apparatus tend to be relatively cumbersome and difficult to install. In general, the services of a skilled electrician are required for connecting the apparatus between the electrical load and the mains electricity supply, and in many cases the services of a skilled telecommunications technician are required for coupling the apparatus to a land line of a telecommunications network. Additionally, such known apparatus, in general, are suitable only for powering up and powering down the electrical load, and thus, where a fault develops in the electrical load, or the power drawn by the electrical load is abnormal or unexpectedly changes, or the electrical load for whatever reason fails to be successfully powered up, one only becomes aware of the problem when one arrives at the house. This is undesirable.

There is therefore a need for a control apparatus for selectively applying a power supply to an electrical load in response to a remotely generated signal which overcomes at least some of the problems of known devices.

The present invention is directed towards providing such a control apparatus.

### SUMMARY OF THE INVENTION

According to the invention there is provided control apparatus for selectively applying an electrical power supply to an electrical load, the control apparatus comprising:
an input means for coupling to the electrical power supply,
an output means for coupling to the electrical load,
a bi-state switch circuit coupled between the input means and the output means for selectively coupling the output means to the input means for applying the electrical power supply to the electrical load,
a first monitoring means for monitoring the presence of an electrical power supply on the input means and for producing a first output signal indicative of the presence of an electrical power supply,
a second monitoring means for monitoring the current being drawn through the output means by the electrical load and for producing a second output signal indicative of the current being drawn through the output means,
a communicating means for communicating the control apparatus with a remote communications device via a telecommunications network,
a control means operably coupled to the switch circuit for controlling the switch circuit for selectively coupling the output means to the input means in response to a control signal received from the remote communications device via the communicating means, the control means being responsive to the first and second output signals from the first and second monitoring means and the state of the switch circuit for determining the operational status of the electrical load, and the control means being responsive to the operational status of the electrical load being abnormal for operating the communicating means for transmitting a status message indicative of the operational status of the electrical load to the remote communications device, and
an electrical power source for powering the control means and the communicating means independently of the electrical power supply coupled to the input means, so that communication may be established between the control means and the remote communications device for controlling the control apparatus in the absence of an electrical power supply on the input means.

The operational status of the electrical load may be abnormal as a result of a number of factors. For example, the electrical load may be faulty, or may have been disconnected from the output means. Alternatively, one or more additional loads may have been unexpectedly coupled to the output means, or alternatively, if the electrical load comprised one or more electrical loads, one or more of the electrical loads may have been unexpectedly disconnected from the output means.

In one embodiment of the invention the control means is responsive to the first signal from the first monitoring means indicating the absence of an electrical power supply on the input means for operating the communicating means for outputting a status signal indicative of the absence of an electrical power supply on the input means.

In another embodiment of the invention the control means is adapted for operating the switch circuit for coupling the output means to the input means at predetermined times for predetermined time periods.

Preferably, the control means is responsive to a control signal from the remote communications device for operating the switch circuit for coupling the output means to the input means at the predetermined times for the predetermined time periods.

In one embodiment of the invention the control means is adapted for timing a twenty-four hour time cycle. Advantageously, the control means is adapted for timing a seven day time cycle. Preferably, the control means is adapted for timing a three hundred and sixty-five day time cycle. By providing the control means to be adapted for timing a seven day time cycle, for example, a one week time cycle, different predetermined times and different predetermined time periods may be selected for the different days of the week. Similarly, where the control means is adapted for timing a three hundred and sixty-five day time cycle, namely, a one year time cycle, different predetermined times and predetermined time periods may be selected for different weeks, and indeed, summer and winter time may be taken account of, and leap years may also be taken account of.

In one embodiment of the invention the second output signal from the second monitoring means is indicative of the level of current being drawn through the output means, and the control means is adapted for comparing the second output signal with an upper current threshold limit, and the control means is responsive to the current being drawn through the output means exceeding the upper current threshold limit for operating the communicating means to transmit a status message to the remote communications device indicative of the current being drawn through the output means exceeding the upper current threshold limit.

Preferably, the status message outputted through the communicating means under the control of the control means in response to the current being drawn through the output means exceeding the upper current threshold limit is indicative of the amount by which the current being drawn through the output means exceeds the upper current threshold limit.

Advantageously, the control means is responsive to the current being drawn through the output means exceeding the upper current threshold limit for operating the switch circuit to isolate the output means from the input means.

In another embodiment of the invention a first storing means is provided for storing the amount by which the current being drawn through the output means exceeds the upper current threshold limit.

In another embodiment of the invention the control means is adapted for comparing the second signal from the second monitoring means with a lower current threshold limit, and the control means is responsive to the current falling below the lower current threshold limit for operating the communicating means for outputting a status message indicative of the current falling below the lower current threshold limit.

In a further embodiment of the invention the status message outputted through the communicating means under the control of the control means in response to the current being drawn through the output means falling below the lower current threshold limit is indicative of the amount by which the current being drawn through the output means falls below the lower current threshold limit.

Advantageously, the control means is responsive to the current drawn through the output means falling below the lower current threshold limit for operating the switch circuit for isolating the output means from the input means.

In one embodiment of the invention a second storing means is provided for storing the amount by which the current being drawn through the output means falls below the lower current threshold limit.

In a further embodiment of the invention the control means is responsive to a status request signal received from the remote communications device through the communicating means for transmitting a status message indicative of the current being drawn through the output means.

Additionally, or alternatively, the second monitoring means may be adapted for monitoring electrical power being drawn through the output means, and the second output signal from the second monitoring means would be indicative of the electrical power being drawn through the output means. Preferably, the control means would be adapted for comparing the second output signal from the second monitoring means with an upper electrical power threshold limit, and the control means would be responsive to the electrical power exceeding the upper electrical power threshold limit for operating the communicating means for outputting a status message indicative of the electrical power exceeding the upper electrical power threshold limit.

Advantageously, the control means may be adapted for comparing the second output signal from the second monitoring means with a lower electrical power threshold limit, and the control means would be responsive to the electrical power falling below the lower electrical power threshold limit for operating the communicating means for outputting a status message indicative of the electrical power falling below the lower electrical power threshold limit.

In another embodiment of the invention the control means may be responsive to the electrical power being drawn through the output means exceeding the upper electrical power threshold limit for operating the switch circuit for isolating the output means from the input means.

In a further embodiment of the invention the control means may be responsive to the electrical power drawn through the output means falling below the lower electrical power threshold limit for operating the switch circuit for isolating the output means from the input means.

In a further embodiment of the invention the control means is responsive to receipt of a control signal received from the remote communications device indicating that the output means is to be coupled to or isolated from the input means, for operating the communicating means to transmit a secondary control signal to other control apparatus for similarly controlling the other control apparatus.

Preferably, the control means is responsive to a secondary control signal received from another control apparatus for appropriately operating the switch circuit.

In one embodiment of the invention the control means is responsive to a secondary control signal for operating the communicating means for transmitting a status message acknowledging receipt of the secondary control signal and indicating that the control means has operated the switch circuit in accordance with the secondary control signal.

Advantageously, at least two output means are provided. Preferably, at least two switch circuits are provided, each switch circuit being operably coupled to the control means and being coupled between a corresponding one of the output means and the input means, so that the output means are operable independently of each other. Ideally, at least two second monitoring means are provided, each second monitoring means being provided for monitoring the current being drawn through a corresponding one of the output means.

In one embodiment of the invention the control means is responsive to the operational status of the electrical load coupled to one of the output means being abnormal for operating the switch circuit corresponding to the output means to which the electrical load of the abnormal status is coupled for isolating the output means from the input means, and for operating the switch circuit corresponding to the other or a predetermined other one of the others of the output means for coupling the other or the predetermined other one of the output means to the input means for applying the electrical power supply to an electrical load coupled to the said other or other one of the output means.

Ideally, the control apparatus is provided as a single integral unit comprising a housing defining a hollow interior region, the control means, the communicating means, the electrical power source, the first mounting means, each second mounting means and each switch circuit being located in the hollow interior region of the housing.

Preferably, at least one of the output means is located in the hollow interior region of the housing and is accessible therethrough, and advantageously, each output means is located in the hollow interior region of the housing and is accessible therethrough.

In one embodiment of the invention at least one of the output means comprises an electrical socket adapted for receiving an electrical plug top.

In another embodiment of the invention each electrical socket is integrally formed in the housing.

In another embodiment of the invention each output means comprises an electrical socket adapted for receiving an electrical plug top.

Alternatively or additionally, at least one of the output means comprises an output electrical terminal block for hardwiring an electrical load thereto.

In one embodiment of the invention each output terminal block is located within the hollow interior region of the housing.

In another embodiment of the invention each output means comprises an electrical terminal block.

In one embodiment of the invention the input means comprises an electrical plug adapted for engaging an electrical socket, and preferably, the electrical plug is integrally formed with the housing.

Alternatively, the electrical plug is located on a cable extending from the housing.

In an alternative embodiment of the invention the input means comprises an input electrical terminal block adapted for hardwiring to the electrical power supply. Preferably, the input terminal block is located in the hollow interior region of the housing.

Ideally, the control means comprises a programmable microcontroller.

Advantageously, the communicating means comprises a communications circuit adapted for communicating with a cellular telecommunications network. Preferably, the communications circuit comprises a messaging interface, and in one embodiment of the invention the messaging interface is a GSM interface. Advantageously, the communications circuit comprises SIM card technology.

In one embodiment of the invention the communicating means monitors the strength of the coverage of a telecommunications network in which it is to communicate, and outputs a signal which is readable by the control means and is indicative of the strength of the coverage of the telecommunications network.

In another embodiment of the invention a means responsive to the control means is provided for outputting a representation of the signal indicative of the strength of the coverage of the telecommunications network which is perceptible to a human. In one embodiment of the invention the representation of the signal is a visual representation, and additionally or alternatively, the representation of the signal is an aural representation.

In one embodiment of the invention the electrical power source comprises a battery, and preferably, the battery is a rechargeable battery. Advantageously, the electrical power source comprises a battery charging circuit, and preferably, the battery charging circuit is coupled to the input means for applying the electrical power supply to the battery charging circuit.

In one embodiment of the invention a third monitoring means is provided for monitoring a parameter external of the control apparatus, and for applying a third output signal to the control means indicative of the status of the parameter being monitored, and preferably, the third monitoring means is adapted for monitoring a parameter of an environment external to the control apparatus.

In one embodiment of the invention the third monitoring means is adapted for monitoring ambient temperature. Additionally, or alternatively, the third monitoring means is adapted for monitoring ambient humidity. Additionally, or alternatively, the third monitoring means is adapted for monitoring the light level in the external environment.

In one embodiment of the invention the control means is responsive to the third output signal being indicative of the status of the parameter being monitored being abnormal for operating the communicating means to transmit a status message indicative of the status of the parameter.

In another embodiment of the invention the control means is responsive to the third output signal being indicative of the light level passing through a predetermined level for operating the switch circuit corresponding to at least one of the output means for coupling or isolating the corresponding output means to or from the input means.

In a further embodiment of the invention an input/output means is provided for inputting a status signal from a device external to the control apparatus, and the control means is responsive to the state of the status signal being indicative of an abnormal condition for operating the communicating means to transmit a status message indicative of the state of the status signal to the remote communications device.

Preferably, the control means is responsive to the state of the status signal from the external device for operating the switch circuit of at least one of the output means for coupling or isolating the output means to or from the input means.

Additionally, the invention provides a method for selectively applying an electrical power supply to an electrical load, in response to a remotely generated control signal, the method comprising the steps of:
providing a control apparatus for selectively applying the electrical power supply to the electrical load,
providing the control apparatus with an input means for coupling to the electrical power supply,
providing the control apparatus with an output means for coupling to the electrical load,
providing the control apparatus with a bi-state switch circuit coupled between the input means and the output means for selectively coupling the output means to the input means for applying the electrical power supply to the electrical load,
providing the control apparatus with a first monitoring means for monitoring the presence of an electrical power supply on the input means and for producing a first output signal indicative of the presence of an electrical power supply,
providing the control apparatus with a second monitoring means for monitoring the current being drawn through the output means by the electrical load and for producing a second output signal indicative of the current being drawn through the output means,
providing the control apparatus with a communicating means for communicating the control apparatus with a remote communications device via a telecommunications network for receiving the remotely generated control signal from the remote communications device,
providing the control apparatus with a control means operably coupled to the switch circuit for selectively coupling the output means to the input means in response to the remotely generated control signal received from the remote communications device via the communicating means, the control means being responsive to the first and second output signals from the first and second monitoring means and the state of the switch circuit for determining the operational status of the electrical load, and the control means being responsive to the operational status of the electrical load being abnormal for operating the communicating means for transmitting a status message indicative of the operational status of the electrical load to the remote communications device,
providing the control apparatus with an electrical power source for powering the control means and the communicating means independently of the electrical power supply coupled to the input means, so that communication may be established between the control means and the remote communications device for controlling the control apparatus in the absence of an electrical power supply on the input supply coupled to the input means, so that communication may be established between the control means and the remote communications device for controlling the control apparatus in the absence of an electrical power supply on the input means, and
transmitting the control signal from the remote communications device to the control apparatus for operating the control means to control the switch circuit for selectively coupling the output means with the input means.

The advantages of the invention are many. By virtue of the fact that the control apparatus according to the invention is provided with an electrical power source for powering the control means and the communicating means, which is independent of the electrical power supply applied to the input means, the control apparatus can communicate the status of the electrical power supply to the remote communications device, even when the electrical power supply fails, and the control means can also control the switch circuit when the electrical power supply fails, so that the switch circuit can be operated under the control of the control means during the failure of the power supply to be in a desired state when the electrical power supply is restored. Furthermore, by virtue of the fact that the control apparatus according to the invention comprises a first and a second monitoring means, the control apparatus can readily determine the operational status of the electrical load. For example, if the first output signal outputted by the first monitoring means is indicative of the presence of the electrical power supply, and the second output signal outputted by the second monitoring means is indicative of no current being drawn through the output means, and if the switch circuit coupling the output means to the input means is in the closed circuit state, then the control means can readily determine that the operational status of the electrical load is abnormal, resulting from, for example, a faulty electrical load or the electrical load having been disconnected from the output means either deliberately or inadvertently. Additionally, on the status of the electrical load being determined as being abnormal, the control means can readily operate the communicating means for transmitting a status message to the remote communications device indicative of the operational status of the electrical load.

A further advantage of providing the electrical power source to be independent of the electrical power supply is that during a power failure of the electrical power supply, the control apparatus can continue to communicate with the remote communications device, and furthermore, the control means of the control apparatus can be operated in response to control signals from the remote communications device, for example, to operate the switch circuit for isolating the output means from the input means so that when the electrical power supply is restored, the electrical load will be isolated from the electrical power supply, or vice versa.

A further advantage is achieved when the control means is programmable for facilitating operation of the switch circuit by the control means for applying the electrical power supply to the electrical load at predetermined times for predetermined time periods, since in such cases, when the control circuit is operated for isolating the output means from the input means during the failure of an electrical power supply, the control means may be programmed while the electrical power supply is absent to operate the switch circuit for applying the electrical power supply to the electrical load at a predetermined time period after the electrical power supply has been restored. A further advantage of the control apparatus when the control means is programmable for operating the switch circuit for applying the electrical power supply to the electrical load at predetermined times for predetermined time periods is obtained when the control apparatus is being used, for example, to control the operation of a central heating system in a holiday house. In such a case the control means may be programmed to operate the switch circuit for applying the electrical power supply to the central heating system for a predetermined time period in the morning, and a predetermined time period in the afternoon or evening, and furthermore, the control means may be programmed not to activate the switch circuit until an appropriate control signal has been received from the remote communications device, and on receipt of the control signal the control apparatus then would operate the switch circuit for applying the electrical power supply to the central heating system during the predetermined time periods in the morning and evening, as appropriate.

A further advantage of the invention is achieved when the control means is adapted for comparing the second output signal outputted by the second monitoring means, which is indicative of the level of the current being drawn through the output means with an upper or lower current threshold limit, since if the current being drawn through the output means exceeds the upper current threshold limit, a status message can be immediately transmitted from the control apparatus to the remote communications device which is indicative of the current being drawn by the electrical load. The status of the load can be determined from the current being drawn, and if the load is determined as being faulty, the faulty load which is drawing excessive current may be switched off by a control signal from the remote communications device, or alternatively, by the control means where the control means is programmed to be responsive to excess current being drawn through the output means for operating the switch circuit for isolating the output means from the input means. Alternatively, if the excessive current is determined as being caused by a number of loads being coupled to the output means, or indeed by one load, and the current being drawn would indicate that at a particular time period during the day or night, such a current would lead to the power consumption in a house or the like being excessive, the switch circuit may be operated under the control of the control means for isolating the output means from the input means for the relevant particular time period. Similarly, where the current being drawn is below the lower current threshold limit, the switch circuit may be operated by the control means or by a control signal from the remote communications device for isolating the load from the electrical power supply. Alternatively, the reason the electrical load is drawing a current below the lower current threshold limit can be investigated.

A further advantage of the invention is achieved when the control means is responsive to a status request from the remote communications device, in that the status of the load and other aspects of the control apparatus can be communicated via appropriate status messages from the control apparatus.

The provision of more than one output means, which preferably, are independent of each other and each are provided with a corresponding switch circuit, has the added advantage that a number of electrical loads can be controlled independently of each other. A further advantage of providing more than one output means is that if two similar type loads, for example, two lights in a room for security purposes, are coupled separately to two of the output means, on the control means determining from the second output signal from the second monitoring means of one of the output means that the corresponding light has failed, the control means can readily operate the switch circuit of that output means for isolating that output means from the input means, and operate the switch circuit of the other output means which is also coupled to a light for coupling the output means of that light to the input means, thereby maintaining a light on in the room.

A particularly important advantage of the invention is achieved when the control apparatus is supplied as a single integral unit, and in particular, as a single integral unit with the input means provided by an electrical plug which is suitable for engaging in an electrical socket, and each output means provided as an electrical socket which is suitable for receiving an electrical plug from a load to be electrically coupled thereto. This advantage is particularly enhanced when the input electrical plug and each output electrical socket are integrally formed with the housing, since the control apparatus can then be provided in a single integral unit which can readily easily be used for coupling an electrical load to an electrical power supply.

By providing the communicating means as a communicating circuit suitable for communicating with a cellular telecommunications network, the control apparatus can readily easily be controlled remotely from a cellular phone, and by providing a suitable messaging interface, such as a GSM interface in the communicating circuit, the control apparatus can readily easily be controlled using SMS messaging.

The provision of the control means as a programmable microcontroller has the advantage that the control apparatus can readily easily be programmed via the communicating means, and indeed, where the communicating means is provided as a communicating circuit suitable for communicating with a cellular telecommunications network, the microcontroller can readily easily be programmed by a remotely located computer also coupled into a cellular telecommunications network.

### BRIEF DESCRIPTION OF THE DRAWINGS

The invention will be more clearly understood from the following description of some preferred embodiments thereof, which are given by way of example only, with reference to the accompanying drawings, in which:

FIG. 1 is a perspective view of control apparatus according to the invention for selectively applying an electrical power supply to an electrical load,

FIG. 2 is a block representation of an electrical circuit of the control apparatus of FIG. 1,

FIG. 3 is a block representation of a part of the electrical circuit of the control apparatus of FIG. 1,

FIG. 4 is a block representation of another part of the electrical circuit of the control apparatus of FIG. 4,

FIG. 5 is a perspective view of control apparatus according to another embodiment of the invention for selectively applying an electrical power supply to two electrical loads,

FIG. 6 is a block representation of an electrical circuit of the control apparatus of FIG. 5,

FIG. 7 is a block representation of an electrical circuit of control apparatus according to another embodiment of the invention for selectively applying an electrical power supply to a plurality of electrical loads,

FIG. 8 is a perspective view of control apparatus according to a further embodiment of the invention for selectively coupling an electrical power supply to two electrical loads,

FIG. 9 is a block representation of an electrical circuit of the control apparatus of FIG. 5, and

FIG. 10 is a perspective view of control apparatus according to a still further embodiment of the invention for selectively applying an electrical power supply to an electrical load.

### DETAILED DESCRIPTION OF THE INVENTION

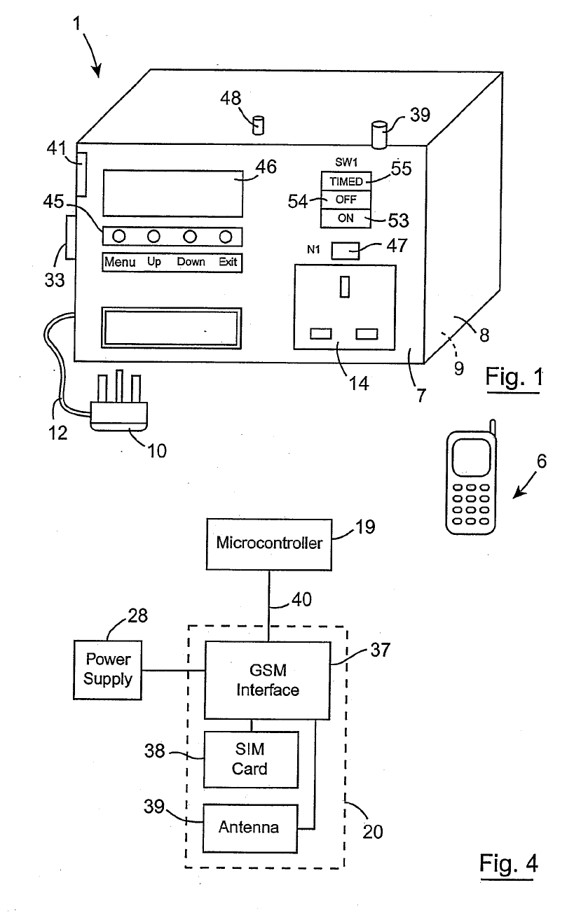

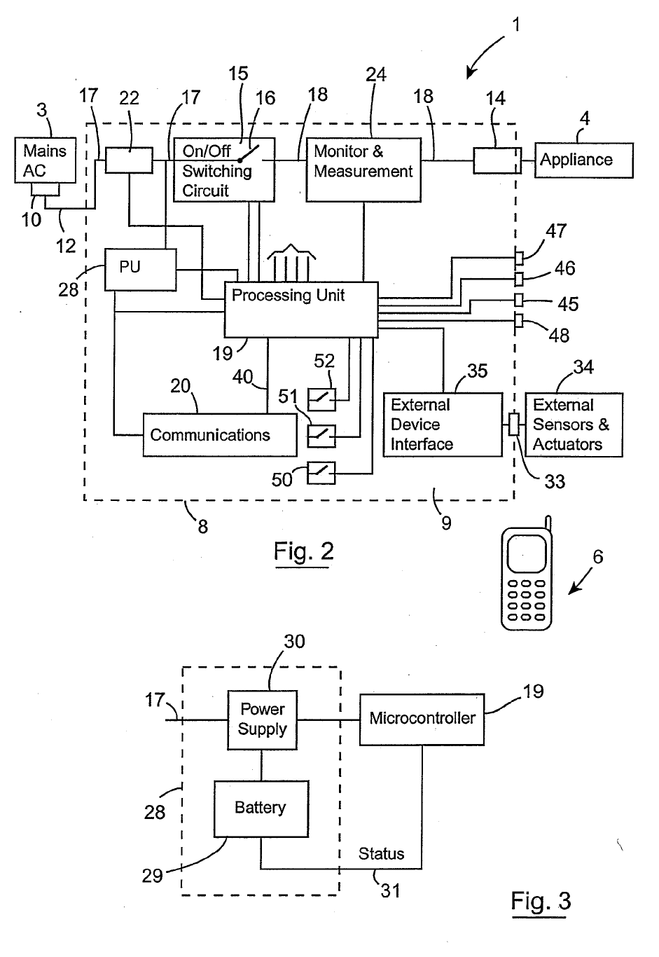

Referring to the drawings and initially to FIGS. 1 to 4, there is illustrated control apparatus according to the invention, indicated generally by the reference numeral 1, for selectively applying an electrical power supply, namely, a mains AC power supply 3 to an electrical load, for example, an appliance 4, such as a table lamp, a central heating system, a washing machine, or indeed any other appliance. The control apparatus 1 is responsive to a control signal from a remote communications device, in this embodiment of the invention a cellular telephone 6, which transmits the control signal in the form of an SMS message for operating the control apparatus 1 for coupling the appliance 4 to the mains supply 3, or for isolating the appliance 4 from the mains supply 3, as will be described in detail below.

The control apparatus 1 is provided as a single integral unit comprising a housing 8 having a front panel 7 and defining a hollow interior region 9 within which components of the control apparatus 1 are housed, as will be described below. An input means for coupling the control apparatus 1 to the mains supply 3 comprises an electrical plug top 10 which is suitable for engaging in an electrical socket (not shown) in which the mains supply 3 is provided. In this embodiment of the invention the electrical plug top 10 is provided on a cable 12 extending from the housing 8.

An output means comprising an electrical socket 14 is integrally formed with the housing 8 for receiving an electrical plug top (not shown) of the appliance 4 for coupling the appliance 4 to the control apparatus 1. A switch circuit 15 located in the hollow interior region 9 of the housing 8 couples the electrical socket 14 to the electrical plug top 10, and comprises a bi-state bi-stable mains power switch 16 for selectively coupling the electrical socket 14 to the electrical plug top 10. An input power line 17 located within the hollow interior region 9 of the housing 8 couples the power switch 16 to the cable 12 from the electrical plug top 10, and an output power line 18 located within the hollow interior region 9 of the housing 8 couples the power switch 16 to the electrical socket 14.

A control means, in this embodiment of the invention a programmable microcontroller 19 located in the hollow interior region 9 of the housing 8 controls the switch circuit 15 and in turn the power switch 16 for selectively coupling the electrical socket 14 to the electrical plug top 10, and for selectively isolating the electrical socket 14 from the electrical plug top 10, as will be described below, in response to a control signal from the remote cellular phone 6.

A communicating means, in this embodiment of the invention a communications circuit 20, which will be described in more detail below with reference to FIG. 4, is located in the hollow interior region 9 of the housing 8 for receiving and transmitting SMS messages to and from the remote cellular phone 6, which are communicated between the communications circuit 20 and the microcontroller 19.

A first monitoring means, namely, a volt meter 22, is located in the hollow interior region 9 of the housing 8 and is coupled to the input power line 17 which couples the electrical plug top 10 to the switch circuit 15 for monitoring the voltage on the input power line 17 for determining the presence or absence of the mains supply 3. The volt meter 22 outputs a first output signal indicative of the status of the mains supply 3, which is read by the microcontroller 19. A second monitoring means comprising an amp meter 24 is located in the hollow interior region 9 of the housing 8 for monitoring current flowing through the output power line 18 which couples the electrical socket 14 with the switch circuit 15 for monitoring current flow in the output power line 18 to the appliance 4. The amp meter 24 outputs a second output signal which is indicative of the level of current flowing in the output power line 18, which is read by the microcontroller 19 for determining the level of current being drawn through the output power line 18 by the appliance 4 and the power consumption of the appliance 4.

The microcontroller 19 is programmable to read the first and second output signals from the volt meter 22 and the amp meter 24, respectively, and to read the state of the power switch 16, and to determine the operational status of the appliance 4 from the status of the first and second output signals and the state of the power switch 16. If the power switch 16 is determined to be in the closed circuit state, the first output signal from the volt meter 22 is indicative of the presence of the mains supply 3, and the second output signal from the amp meter 24 is indicative of no current being drawn through the output power line 18, the operational status of the appliance 4 is determined as being abnormal, which may be as a result of the appliance 4 being disconnected or being faulty. Further, the microcontroller 19 is programmable so that on determining that the operational status of the appliance 4 is abnormal, the microcontroller 19 operates the communications circuit 20 for transmitting an SMS status message to the cellular telephone 6, indicating the abnormal operational status of the appliance 4. The microcontroller 19 may also be programmed to operate the switch circuit 15 for operating the power switch 16 in the open circuit state in response to the appliance 4 being determined as being of abnormal operational status, or the microcontroller 19 may be programmed to await an SMS control message from the cellular telephone 6 to operate the switch circuit 15 for operating the power switch 16 in the open circuit state.

Additionally, the microcontroller 19 is programmable so that on the first signal from the volt meter 22 being indicative of the absence of the main supply 3, irrespective of whether an electrical load is coupled to the electrical socket 14, the microcontroller 19 operates the communications circuit 20 for transmitting an SMS status message indicating the status of the mains supply 3. Thus, if the appliance is coupled to the electrical socket 14, and if the switch circuit 15 is operated with the power switch 16 in the closed circuit state when the mains supply 3 fails, if it is desirable that the appliance 4 should not be powered up immediately on the main supply 3 being restored, an SMS control message can be transmitted from the cellular telephone 6 to the control apparatus 1, and on reception thereof, the microcontroller 19 operates the switch circuit 15 for operating the power switch 16 into the open circuit state, so that when the mains supply 3 is restored, the appliance 4 will be isolated from the mains supply 3.

A power supply source provided by a power supply circuit 28 is located in the hollow interior region 9 of the housing 8, and powers the microcontroller 19 and the communications circuit 20 as well as the volt meter 22 independently of the mains supply 3 so that in the event of failure of the mains supply 3, the microcontroller 19 and the communications circuit 20 are still powered for facilitating control of the control apparatus 1 and communication between the control apparatus 1 and the cellular telephone 6. The power supply circuit 28 comprises a rechargeable battery 29 and a battery charging circuit 30, see FIG. 3. The battery charging circuit 30 is coupled to the input power line 17 for charging the battery 29 from the mains supply 3 on the input power line 17. Additionally in this embodiment of the invention the microcontroller 19 and the communications circuit 20 are powered directly from the battery 29 so as to avoid power surges and spikes from the mains supply 3 being coupled to the microcontroller 19 and the communications circuit 20. The microcontroller 19 continuously monitors the status of the battery 29 on a status monitoring line 31 for determining the power level in the battery 29, and on the power level in the battery 29 falling below a first predetermined level which is pre-programmed into the microcontroller 19, the microcontroller 19 instructs the battery charging circuit 30 to charge the battery 29. In the event of the power level in the battery 29 falling below a second predetermined level during an extended power failure, the microcontroller 19 operates the communicating circuit 20 for outputting an SMS status message to the cellular telephone 6 indicative of the power level in the battery 29, so that appropriate corrective action can be taken before the power level in the battery becomes exhausted. The second predetermined level is programmable into the microcontroller 19, and would be set at a level to leave sufficient time to take the appropriate corrective action prior to the battery being exhausted.

An input/output means, namely, an I/O terminal 33 is integrally formed in the housing 8 and is coupled to the microcontroller 19 through an interface circuit 35, also located in the hollow interior region 9, for facilitating communication between the microcontroller 19 and one or more external devices 34, which may, for example, be a burglar alarm system, a smoke detector system or the like. The microcontroller 19 is programmable so that on receipt of a signal from the external device or devices indicative of an alarm or other such condition, the microcontroller 19 operates the communications circuit 20 to transmit an SMS status message to the cellular telephone 6 indicative of the status of the signal from the external device 34. The microcontroller 19 is also programmable to interrogate the external devices 34 in response to an SMS status request message from the cellular telephone 6, and to operate the communications circuit 20 for transmitting an SMS status message to the cellular telephone 6 in response to the interrogation of the external device or devices 34. The microcontroller 19 may also be programmed for delivering digital signals through the I/O terminal 33 for instructing one or more of the external devices 34 to perform a predetermined operation in response to an SMS control signal received from the cellular telephone 6.

Turning now to the communications circuit 20 and referring in particular to FIG. 4, the communications circuit 20 comprises a messaging interface circuit, which in this case is a GSM interface circuit 37, which interfaces with a SIM card interface circuit 38. The SIM card interface circuit 38 incorporates an appropriate SIM card holder (not shown), and a receiving slot 41 in the housing 8 accommodates a SIM card into the SIM card holder. An antenna 39 extending from the housing 8 is coupled to the GSM interface circuit 37. The GSM interface circuit 37 interfaces with the microcontroller 19 through a communications bus 40 for outputting SMS control messages to the microcontroller 19 received from the cellular telephone 6, and for receiving SMS status messages from the microcontroller 19 for transmission by the communications circuit 20 to the cellular telephone 6.

The microcontroller 19 is also programmable to operate the switch circuit 15 at predetermined times for operating the power switch 16 in the closed circuit state for predetermined time periods. A keypad 45 is provided in the front panel 7 of the housing 8 for facilitating selection of predetermined times and predetermined time periods at which and during which the switch circuit 15 is to be operated for operating the power switch 16 in the closed circuit state. A display means provided by a liquid crystal display 46 displays times and under the control of the keypad 45 and the microcontroller 19 scrolls times so that by using the keypad 45 and the liquid crystal display 46 in combination, the predetermined times and the predetermined time periods can be selected. The selection of such predetermined times and predetermined time periods using such a liquid crystal display in which times are scrolled and a keypad will be well known to those skilled in the art.

In this embodiment of the invention the microcontroller 19 is programmable so that the predetermined times and the predetermined time periods can be programmed in a three hundred and sixty-five day cycle, in other words, in a yearly cycle. When the microcontroller 19 is programmed with the desired predetermined times and predetermined time periods, the microcontroller 19 waits for either an SMS control message from the cellular telephone 6 to commence operating the switch circuit 15 based on the predetermined times and predetermined time periods, or a control message from the cellular telephone 6 to cease operating the switch circuit 15 based on the predetermined times and predetermined time periods.

An indicating means provided by a light emitting diode 47 on the front panel 7 indicates the state of the power switch 16 of the switch circuit 15.

The GSM interface circuit 37 monitors the strength of the GSM network coverage for determining whether the communications circuit 20 will be able to transmit and receive SMS messages to and from the cellular telephone 6. The GSM interface circuit 37 generates a signal indicative of the strength of the coverage of the GSM network, and the microcontroller 19 is programmed to read the strength signal from the GSM interface circuit 37 in response to an instruction entered through the keypad 45 and to display a visually perceptible graphical representation of the strength signal on the liquid crystal display 46 indicating the strength of the coverage of the telecommunications network. This, thus, permits the control apparatus to be located in a position in a house or other building, as the case may be, where the GSM network coverage is strongest. The keypad 45 includes a menu select button, which permits the liquid crystal display 46 to be operated for displaying the graphical representation of the strength signal.

Three manually operated push button bi-state, mono-stable, normally open first, second and third switches 50, 51 and 52 are located in the hollow interior region 9 of the housing 8, and are operable by first, second and third push buttons 53, 54 and 55, respectively, located in the front panel 7 of the housing 8 for facilitating manual operation of the control apparatus 1. The manually operated first, second and third switches 50, 51 and 52 are coupled to the microcontroller 19, and the state of the switches 50, 51 and 52 is continuously read by the microcontroller 19. The manually operated first switch 50 is provided for operating the switch circuit 15 for coupling the electrical socket 14 to the electrical plug top 10. The manually operated second switch 51 is provided for selectively operating the switch circuit 15 for isolating the electrical socket 14 from the electrical plug top 10. The microcontroller 19, on determining the first switch 50 being momentarily operated in the closed circuit state, operates the switch circuit 15 for in turn operating the power switch 16 into the closed circuit state for coupling the electrical socket 14 to the electrical plug top 10. The microcontroller 19 is responsive to the second switch 51 being momentarily operated in the closed circuit state for operating the switch circuit 15 for in turn operating the power switch 16 into the open circuit state for isolating the electrical socket 14 from the electrical plug top 10. Thus, once the manually operable first switch 50 is operated momentarily in the closed circuit state, the microcontroller 19 operates the switch circuit 15 for continuously coupling the electrical socket 14 to the electrical plug top 10 until the manually operable second switch 51 is operated momentarily in the closed circuit state, at which stage the microcontroller 19 operates the switch circuit 15 for isolating the electrical socket 14 from the electrical plug top 10. The microcontroller 19 is responsive to the manually operable third switch 52 being momentarily operated in the closed circuit state for controlling the switch circuit 15 for coupling the electrical socket 14 to the electrical plug top 10 at the predetermined times for the predetermined time periods which are programmed into the microcontroller 19 until the second switch 51 is again momentarily operated in the closed circuit state.

However, the microcontroller 19 is programmable so that the manually operable first, second and third switches 50, 51 and 52 can be overridden by an SMS control signal from the cellular telephone 6. In which case, the microcontroller 19 would ignore operation of the manually operable first, second and third switches 50, 51 and 52 while the microcontroller 19 was being operated in response to an SMS control signal to override the manually operable first, second and third switches 50, 51 and 52.

A third monitoring means, namely, a temperature sensor 48 is located on the housing 8 for detecting ambient temperature externally of the control apparatus 1. The temperature sensor 48 outputs third output signals 48 indicative of the temperature read by the temperature sensor 48, which are applied to the microcontroller 19.

In this embodiment of the invention the microcontroller 19 is also programmable to compare the second output signal received from the amp meter 24, which is indicative of the level of current being drawn through the output power line 18, with upper and lower current threshold limits. Selected upper and lower current threshold limits are programmable into the microcontroller 19 through the cellular telephone 6 via the communications circuit 20 and are appropriate to the maximum and minimum currents which should be drawn by the appliance 4 which is coupled to the electrical socket 14. On the microcontroller 19 determining that the current being drawn through the output power line 18 either exceeds the upper current threshold limit or falls below the lower current threshold limit, the microcontroller 19 operates the communications circuit 20 for outputting an SMS status message which is indicative of the value of the current being drawn through the output power line 18, or the amount by which the current being drawn through the output power line 18 exceeds or falls below the upper current threshold limit or the lower current threshold limit as the case may be. The microcontroller 19 may also be programmed to operate the switch circuit 15 for operating the power switch 16 in the open circuit state in response to the current being drawn through the output power line 18 exceeding the upper current threshold limit or falling below the lower current threshold limit as the case may be for isolating the appliance 4 from the mains supply 3.

The microcontroller 19 is also programmable to receive status requests from the cellular telephone 6 in the form of SMS status request messages requesting the status of the appliance 4 and other aspects of the control apparatus 1, and in response to such status requests, the microcontroller 19 controls the communications circuit 20 for outputting an appropriate SMS status message indicating the status of the appliance 4 or other aspects of the control apparatus 1, for example, the status of the mains supply 3, the operational status of the appliance 4, the state of the power switch 16, the level of current being drawn through the output power line 18, the status of the battery 29, the status of the ambient temperature external of the control apparatus 1 monitored by the temperature sensor 48, the status of signals received from the external device 34, and any other items of which the status may be required, for example, a schedule of the predetermined times and predetermined time periods at which the switch circuit 15 is to be operated.

Additionally, in this embodiment of the invention the control apparatus 1 is password protected, and accordingly, the microcontroller 19 is only responsive to SMS control messages and SMS status request messages when such messages are accompanied by a password, in this embodiment of the invention a personal identification number. The microcontroller 19 is programmed to compare the personal identification number forming part of each SMS control message and SMS status request message with a stored personal identification number, and if the personal identification number of the received message does not compare with the stored personal identification number, the message is ignored. By password protecting the control apparatus 1, the control apparatus 1 may be operated to be responsive to any cellular telephone, provided the SMS control message or the SMS status request message is accompanied by the appropriate password. Additionally, the microcontroller 19 is programmable to communicate only with one cellular telephone 6, although the microcontroller 19 may be programmed to communicate with a number of different cellular telephones, and the numbers of such cellular telephone or telephones are stored in the microcontroller 19. Thus, in the event of the communications circuit 20 being operated to communicate an SMS status message by the microcontroller 19 which has been initiated by the microcontroller 19, as opposed to being initiated by an SMS status request message, the microcontroller 19 sequentially outputs the SMS status message until it receives an acknowledgement from one of the cellular telephones that the SMS status message has been received. The telephone numbers of the cellular telephones 6 stored in the microcontroller 19 are ranked in a priority order which determines the sequence in which the SMS status message is to be transmitted to the respective cellular telephones 6, until an acknowledgement of the SMS status message has been received.

The microcontroller 19 is also programmable for phone number verification, so that if an SMS control message or an SMS status request message is received from a non-valid phone number, even if the SMS control message or the SMS status request message is accompanied by a valid password, the microcontroller 19 ignores the SMS control or status request message, as the case may be. In which case, the valid phone numbers from which SMS control messages and/or SMS status request messages may be validly received are stored in memory in the microcontroller 19.

In this embodiment of the invention the microcontroller 19 is also programmable to act in a master/slave arrangement with other control apparatus similar to the control apparatus 1. In which case, on receiving an SMS control message for operating the switch circuit 15 to operate the power switch 16 in either the closed circuit state or the open circuit state, the microcontroller 19 is programmed to operate the switch circuit 15 appropriately, and also is programmed to operate the communications circuit 20 to retransmit a secondary signal, namely, a secondary SMS control message corresponding to the SMS control message received from the cellular telephone 6 to the other control apparatus similar to the control apparatus 1, which would be programmed to act as slaves to the master control apparatus 1. Each slave control apparatus is appropriately programmed so that on receipt of the secondary SMS control message from the master control apparatus 1, the slave control apparatus 1 would operate its switch circuit 15 for similarly and appropriately controlling an electrical power supply to an electrical load coupled to the slave control apparatus. Each slave control apparatus is also programmed so that on receipt of a secondary SMS control message from the master control apparatus, and on having appropriately operated the switch circuit 15, the slave control apparatus would then operate its communications circuit 20 for transmitting to the master control apparatus 1, an SMS acknowledgement message confirming receipt of the secondary SMS control message, and also confirming that the switch circuit has been appropriately operated. The master control apparatus 1 on receipt of the SMS acknowledgement message from one or all of the slave control apparatus would operate its communications circuit 20 for transmitting a corresponding SMS acknowledgement and confirmatory message to the cellular telephone 6. The control apparatus, which are programmed to operate in a master/slave arrangement, may also be programmed to transmit and exchange SMS status request messages and SMS status messages, for relaying between the master control apparatus 1 and the cellular telephone 6.

In use, the control apparatus 1 is coupled to a mains supply 3 by plugging the electrical plug top 10 into a suitable socket in which the mains supply 3 is provided. The appliance 4 to be controlled by the control apparatus 1 is coupled to the electrical socket 14. The microcontroller 19 is appropriately programmed as desired, and in response to SMS control messages and SMS status messages operates as described above. In the case of receiving an SMS control message for operating the switch circuit 15 for applying the mains supply 3 to the appliance 4 or for isolating the appliance 4 from the mains supply 3, the microcontroller 19 operates the switch circuit 15 for operating the power switch 16 in the appropriate one of the closed and open circuit states. If the microcontroller 19 is programmed to maintain the mains supply 3 to the appliance 4 for a predetermined time period or periods at predetermined times, the microcontroller 19 appropriately operates the switch circuit 15 on receiving the appropriate SMS control message.

On receipt of an SMS status request message, the microcontroller 19 operates the communications circuit 20 for outputting an SMS status message indicative of the status of the component, the status of which is requested in the SMS status request message.

On any of the parameters being monitored by the volt meter 22, the amp meter 24 and the temperature sensor 48 or in response to a signal from an external device 34 received on the I/O terminal 33 being indicative of an abnormal state, the microcontroller 19 operates the communications circuit 20 for transmitting an appropriate SMS status message to the cellular telephone 6. In the absence of a response from the cellular telephone 6, the microcontroller 19 transmits the appropriate SMS status message sequentially to other cellular telephones, the numbers of which are stored in the microcontroller 19 until an acknowledgement of receipt of the SMS status message has been received. Additionally, in the event of certain of the parameters being monitored being indicative of an abnormal state, depending on how the microcontroller 19 is programmed, the microcontroller 19 may operate the switch circuit 15 to operate the power switch 16 in an appropriate one of the open circuit state or the closed circuit state.

The microcontroller 19 may be programmed by the cellular telephone 6 or by a computer coupled to a cellular network through the cellular telephone 6, or provision may be provided for programming the microcontroller 19 directly by an interface (not shown) in the control apparatus 1 for interfacing the microcontroller 19 with a computer.

Additionally, the microcontroller 19 may be programmed to store the status of the various parameters read, for example, for storing the value of the last read current being drawn by the load, the last operational status of the load determined by the microcontroller 19, the last read temperature from the temperature sensor 48, etc., and on receipt of an SMS status request message from the cellular phone 6 would output the stored status of the parameters.

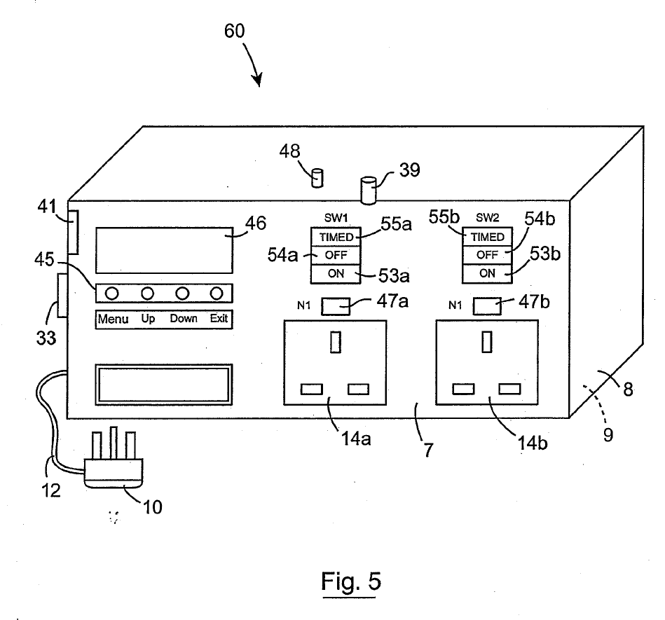

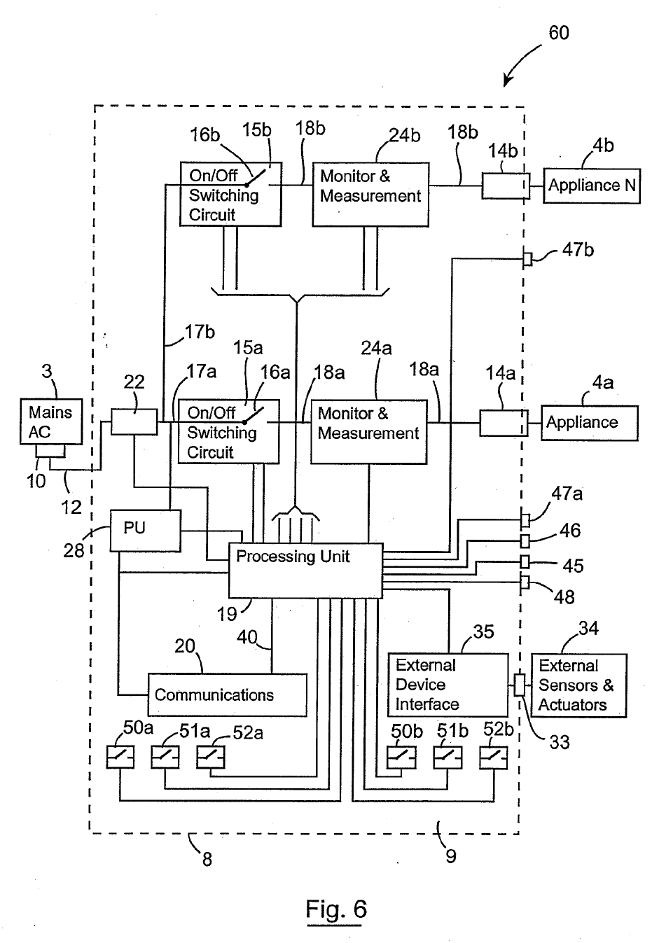

Referring now to FIGS. 5 and 6, there is illustrated a control apparatus according to another embodiment of the invention, indicated generally by the reference numeral 60. The control apparatus 60 is substantially similar to the control apparatus 1 and similar components are identified by the same reference numerals. The main difference between the control apparatus 60 and the control apparatus 1 is that the control apparatus 60 is provided with two output means, namely, two electrical sockets 14a and 14b, and each electrical socket 14a and 14b is coupled to the electrical plug top 10 through a corresponding switch circuit 15a and 15b, which are similar to the switch circuit 15 of the control apparatus 1. Output power lines 18a and 18b couple the electrical sockets 14a and 14b to power switches 16a and 16b, respectively of the corresponding switch circuits 15a and 15b, and input power lines 17a and 17b couple the switch circuits 15a and 15b to the cable 12 from the electrical plug top 10. Amp meters 24a and 24b are provided for the respective output power lines 18a and 18b for monitoring the level of current being drawn through the respective output power lines 18a and 18b. The switch circuits 15a and 15b are independently controlled and operated by the microcontroller 19. The microcontroller 19 is thus responsive to SMS control messages from the cellular telephone 6 which identify the switch circuit 15a or 15b to which the SMS control message relates for in turn operating the identified switch circuit 15a or 15b, or both for applying the mains supply 3 to the appliances 4a and/or 4b or isolating the appliances 4a and/or 4b from the mains supply 3. Additionally, SMS status messages sent under the control of the microcontroller 19 to the cellular telephone 6 identify the electrical socket 14a or 14b, the amp meter 24a or 24b and the switch circuit 15a or 15b, the status of which the SMS status message relates.

Manually operated push button first, second and third switches 50a, 51a and 52a are provided together with corresponding first, second and third push buttons 53a, 54a for facilitating manual control of the switch circuit 15a in a similar manner to that described with reference to the control apparatus 1. Manually operated push button first, second and third switches 50b, 51b and 52b, together with corresponding first, second and third push buttons 53b, 54b and 55b are provided for manually operating the switch circuit 15b in a similar manner as described with reference to the control apparatus 1.

A particular advantage of the control apparatus 60 is that it can be used for controlling the mains supply to two appliances 4a and 4b, one of which may be a standby appliance for the other. For example, the appliances 4a and 4b coupled to the sockets 14a and 14b, respectively, may each be table lamps in a room, and the microcontroller 19 in response to an SMS control message from the cellular telephone 6 may be programmed to operate one of the switch circuits 15, for example, the switch circuit 15a for applying the mains supply 3 to the table lamp coupled to the electrical socket 14a, and on the microcontroller 19 determining that the operational status of the table lamp coupled to the electrical socket 14a is faulty, the microcontroller 19 would operate the switch circuit 15a to operate the power switch 16a in the open circuit state, and would operate the switch circuit 15b to operate the power switch 16b in the closed circuit state for applying the mains supply 3 to the table lamp coupled to the electrical socket 14b so that the room would be continuously illuminated.

Otherwise, the control apparatus 60 is similar to the control apparatus 1 and its operation is likewise similar.

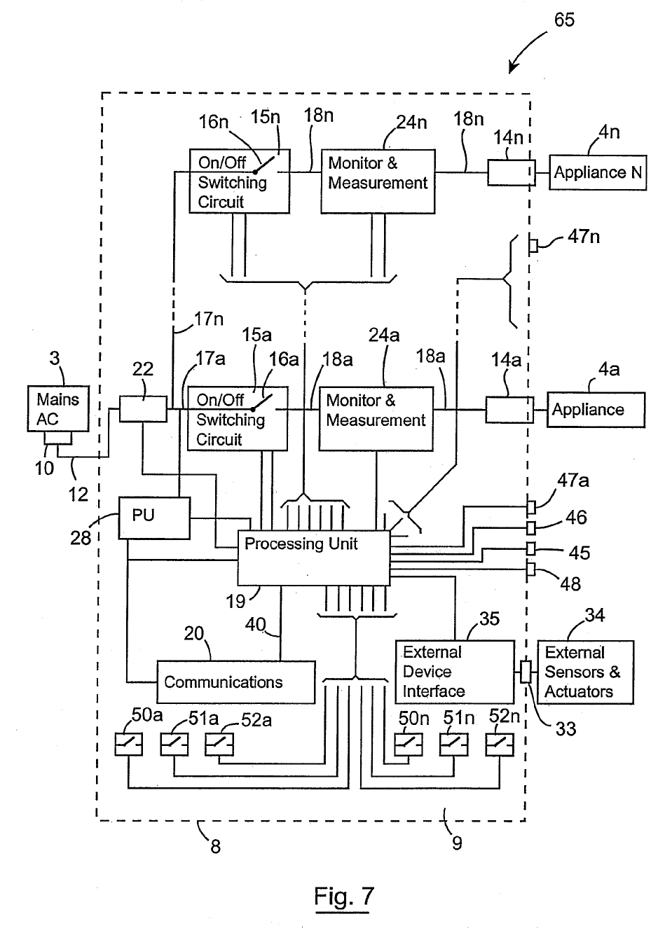

Referring now to FIG. 7, there is illustrated control apparatus according to another embodiment of the invention, indicated generally by the reference numeral 65. The control apparatus 65 is substantially similar to the control apparatus 1 and 60, and similar components are identified by the same reference numerals. The main difference between the control apparatus 65 and the control apparatus 1 is that a plurality of output means, namely, a plurality of electrical sockets 14a to 14n, are provided. Each electrical socket 14a to 14n is coupled to a corresponding switch circuit 15a to 15n, respectively, which are similar to the switch circuit 15 of the control apparatus 1 by corresponding output power lines 18a to 18n. Each switch circuit 15a to 15n is coupled to the cable 12 from the electrical plug top 10 through a corresponding input power line 17a to 17n. Additionally, amp meters 24a to 24n are provided for monitoring the level of current being drawn through the output power lines 18a to 18n, respectively.

The switch circuits 15a to 15n are independently operable and controlled by the microcontroller 19 so that the mains supply 3 can be applied to the electrical sockets 14a to 14n independently of each other.

A plurality of light emitting diodes (not shown) are provided on the front panel 7, one light emitting diode corresponding to each power switch 16 for indicating the state of the power switch 16.

Otherwise, the apparatus 65 is similar to the apparatus 1 and similar components are identified by the same reference numerals.

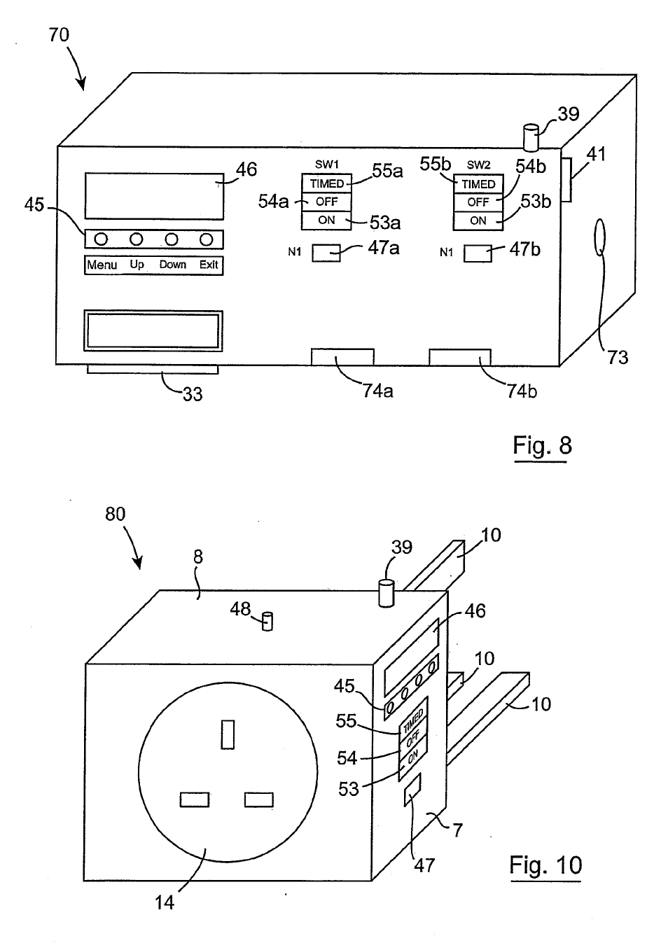

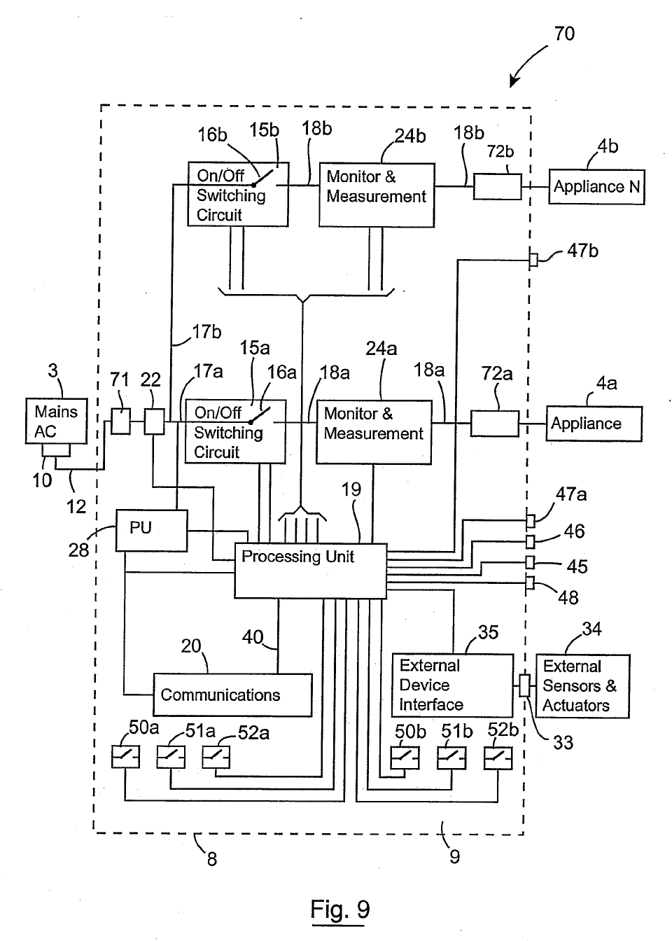

Referring now to FIGS. 8 and 9, there is illustrated control apparatus according to another embodiment of the invention, indicated generally by the reference numeral 70. The control apparatus 70 is substantially similar to the control apparatus 1 and similar components are identified by the same reference numerals. The main difference between the control apparatus 70 and the control apparatus 1 is that in the control apparatus 70 the input and output means are provided by respective input and output electrical terminal blocks 71 and 72, respectively, which are located within the hollow interior region 9 of the housing 8. Two output electrical terminal blocks 72a and 72b are provided, which are coupled to corresponding switch circuits 15a and 15b by output power lines 18a and 18b. The input electrical terminal block 71 is provided for hardwiring the control apparatus 70 to the mains supply 3, and each output terminal block 72a and 72b is provided for hardwiring to a corresponding appliance 4a and 4b. A cable inlet 73 is provided in the housing 8 for accommodating a mains power supply cable into the hollow interior region 9 for connecting to the input terminal block 71, and a pair of cable outlets 74a and 74b in the housing 8 accommodate respective cables from the output terminal blocks 72a and 72b, respectively, to the respective appliances 4a and 4b. The input terminal block 71 is coupled to each switch circuit 15a and 15b by a corresponding input power line 17a and 17b similar to the input power line 17 of the apparatus 1. The switch circuit 15a and 15b are independently operable by the microcontroller 19. A volt meter 22 and amp meters 24a and 24b similar to the volt meter 22 and the amp meter 24 of the apparatus 1 are provided for monitoring the presence of the mains supply 3 on the input terminal block 71 and the current being drawn through the respective output power lines 18a and 18b, respectively, by the respective appliances 4a and 4b.

Otherwise, the control apparatus 70 is similar to the control apparatus 1 and its operation is likewise similar to that of the control apparatus 1 and 60.

While the control apparatus 70 has been described as comprising two output terminal blocks 72, it is envisaged that the control apparatus may be provided with only one output terminal block, or may be provided with many more output terminal blocks, and each terminal block 72 would be coupled through a corresponding switch circuit to the input terminal block 71, and the respective switch circuits would be independently operable and controlled by the microcontroller 19 so that the mains supply 3 could be independently applied to each output terminal block 72 independently of each other.

Referring now to FIG. 10, there is illustrated control apparatus according to another embodiment of the invention, indicated generally by the reference numeral 80, also for selectively coupling a mains electrical power supply to an electrical load. In this embodiment of the invention the control apparatus 80 is substantially similar to the control apparatus 1 and similar components are identified by the same reference numerals. The main difference between the control apparatus 80 and the control apparatus 1 is that in the control apparatus 80 the input means is provided by an electrical plug top 10 which is integrally formed with the housing 8. Otherwise, the control apparatus 80 is similar to the control apparatus 1 and its operation is likewise similar.

While the control apparatus 1, 60, 65 and 80 have been described as comprising electrical plug tops and electrical sockets of the three-pin type according to British Standards, it will be readily apparent to those skilled in the art that the electrical plug tops and electrical sockets may be to any other standard.

While the third monitoring means has been described for monitoring ambient temperature of the environment externally of the control apparatus, it will be readily apparent to those skilled in the art that the third monitoring means may be adapted for monitoring any other parameter of the environment external of the control apparatus, for example, humidity, light level or the like. Where the third monitoring means is provided for monitoring light level, it is envisaged that the microcontroller 19 would be responsive to the third signal from the third monitoring means being indicative of the ambient light falling below a predetermined level for operating the switch circuit 15 to operate the power switch 16 in the closed circuit state for applying the mains supply 3 to an appliance 4 where the appliance 4 is a light, and for operating the power switch 16 in the open circuit state when the light level exceeded the predetermined state.

While the power switch has been described as being a bi-state bi-stable switch, it will be readily apparent to those skilled in the art that it is not essential that the power switch be bi-stable.

While the control apparatus have been described as producing an SMS status message which is indicative of the level of current in the event of the current being drawn through the output power line exceeding an upper current threshold limit or falling below the lower current threshold limit, instead of the SMS status message outputted by the control apparatus being indicative of the level of the current, the SMS status message may merely indicate an over-current condition or an under-current condition without including the value of the current.

It is also envisaged in certain cases that where the control apparatus is provided with more than one electrical socket or one output terminal block, a single switch circuit in certain cases may be provided for controlling all the electrical sockets or terminal blocks. In which case, the mains supply would be applied to each of the electrical sockets or terminal blocks simultaneously. A control apparatus configured in this way would be suitable where it is desired to control a plurality of electrical loads simultaneously so that electrical power is supplied to all the loads at the same time and isolated from all the loads at the same time.

While the control apparatus has been described as comprising an external antenna, it is envisaged in certain cases that the control apparatus may be provided with the antenna located internally in the housing within the hollow interior region 9.

It is also envisaged that the control apparatus may be provided with different levels of password protection, whereby one password would permit access to all features of the control apparatus, while other passwords would provide only limited access, and the limited access provided by the respective passwords may be different. It is also envisaged that the control apparatus may be used to remotely lock out a power supply to a load, for example, to office equipment, home internet access, etc.

Another advantage of the invention is provided when the microcontroller is programmable on a yearly basis, since account can automatically be taken of summer time and winter time, as well as leap years.

Although not described, it is envisaged that the control apparatus may be used for current profiling, whereby a typical profile of the current which should be drawn by a load would be stored, and the actual current being drawn by the load through the output power line would be compared with the stored current profile.

While the first monitoring means has been described as being a volt meter, and the second monitoring means has been described as being an amp meter, any other suitable first monitoring means may be provided for monitoring the status of the mains supply on the input means, and any other suitable second monitoring means may be provided for monitoring the current being drawn through the output means. Indeed, in certain cases, it is envisaged that the second monitoring means may be provided as an electrical power monitoring circuit for monitoring the electrical power being drawn by the electrical load or loads, as the case may be. Such electrical power monitoring circuits, typically, would monitor the voltage, the current, the phase and frequency of the electrical power supply being drawn through the output means by the load. Where the second monitoring means is provided as an electrical power monitoring circuit, the microcontroller would be programmable for comparing the electrical power being drawn through the output means with upper and lower electrical power threshold limits, and would operate as already described should the electrical power being drawn exceed the upper electrical power threshold limit or fall below the lower electrical power threshold limit.

Indeed, where the second monitoring means is provided for monitoring the power supply, the control apparatus could also be used for managing the power supply in a building, and this is particularly so in the case of the control apparatus 65, which is provided with a plurality of independently controlled electrical sockets. Where the total power supply being drawn by the loads which are coupled to the control apparatus exceeds a predetermined level, the microcontroller 19 could be programmed to selectively switch in and switch out various loads.

While the display means has been described as a liquid crystal display, any other suitable display means may be used. Additionally, while light emitting diodes have been described as indicating means for indicating the state of the power switch, any other suitable indicating means may be used. Indeed, in certain cases, it is envisaged that an indicating means provided by a neon light may be used.

1. Control apparatus for selectively applying an electrical power supply to an electrical load, the control apparatus comprising:
an input means for coupling to the electrical power supply,
an output means for coupling to the electrical load,
a bi-state switch circuit coupled between the input means and the output means for selectively coupling the output means to the input means for applying the electrical power supply to the electrical load,
a first monitoring means for monitoring the presence of an electrical power supply on the input means and for producing a first output signal indicative of the presence of an electrical power supply,
a second monitoring means for monitoring the current being drawn through the output means by the electrical load and for producing a second output signal indicative of the current being drawn through the output means,
a communicating means for communicating the control apparatus with a remote communications device via a telecommunications network,
a control means operably coupled to the switch circuit for controlling the switch circuit for selectively coupling the output means to the input means in response to a control signal received from the remote communications device via the communicating means, the control means being responsive to the first and second output signals from the first and second monitoring means and the state of the switch circuit for determining the operational status of the electrical load, and the control means being responsive to the operational status of the electrical load being abnormal for operating the communicating means for transmitting a status message indicative of the operational status of the electrical load to the remote communications device, and
an electrical power source for powering the control means and the communicating means independently of the electrical power supply coupled to the input means, so that communication may be established between the control means and the remote communications device for controlling the control apparatus in the absence of an electrical power supply on the input means.

2. Control apparatus as claimed in claim 1 in which the control means is
responsive to the first signal from the first monitoring means indicating the absence of an electrical power supply on the input means for operating the communicating means for outputting a status signal indicative of the absence of an electrical power supply on the input means, and preferably, the control means is adapted for operating the switch circuit for coupling the output means to the input means at predetermined times for predetermined time periods, and advantageously, the control means is responsive to a control signal from the remote communications device for operating the switch circuit for coupling the output means to the input means at the predetermined times for the predetermined time periods, and preferably, the control means is adapted for timing a twenty-four hour time cycle, and advantageously, the control means is adapted for timing a seven day time cycle, and preferably, the control means is adapted for timing a three hundred and sixty-five day time cycle.

3. Control apparatus as claimed in claim 1 in which the second output signal
from the second monitoring means is indicative of the level of current being drawn through the output means, and the control means is adapted for comparing the second output signal with an upper current threshold limit, and the control means is responsive to the current being drawn through the output means exceeding the upper current threshold limit for operating the communicating means to transmit a status message to the remote communications device indicative of the current being drawn through the output means exceeding the upper current threshold limit, and preferably, the status message outputted through the communicating means under the control of the control means in response to the current being drawn through the output means exceeding the upper current threshold limit is indicative of the amount by which the current being drawn through the output means exceeds the upper current threshold limit, and advantageously, the control means is responsive to the current being drawn through the output means exceeding the upper current threshold limit for operating the switch circuit to isolate the output means from the input means, and preferably, a first storing means is provided for storing the amount by which the current being drawn through the output means exceeds the upper current threshold limit.

4. Control apparatus as claimed in claim 1 in which the control means is
adapted for comparing the second signal from the second monitoring means with a lower current threshold limit, and the control means is responsive to the current falling below the lower current threshold limit for operating the communicating means for outputting a status message indicative of the current falling below the lower current threshold limit, and preferably, the status message outputted through the communicating means under the control of the control means in response to the current being drawn through the output means falling below the lower current threshold limit is indicative of the amount by which the current being drawn through the output means falls below the lower current threshold limit, and advantageously, the control means is responsive to the current drawn through the output means falling below the lower current threshold limit for operating the switch circuit for isolating the output means from the input means, and preferably, a second storing means is provided for storing the amount by which the current being drawn through the output means falls below the lower current threshold limit.

5. Control apparatus as claimed in claim 3 in which the control means is responsive to a status request signal received from the remote communications device through the communicating means for transmitting a status message indicative of the current being drawn through the output means, and preferably, the control means is responsive to receipt of a control signal received from the remote communications device indicating that the output means is to be coupled to or isolated from the input means, for operating the communicating means to transmit a secondary control signal to other control apparatus for similarly controlling the other control apparatus, and preferably, the control means is responsive to a secondary control signal received from another control apparatus for appropriately operating the switch circuit, and preferably, the control means is responsive to a secondary control signal for operating the communicating means for transmitting a status message acknowledging receipt of the secondary control signal and indicating that the control means has operated the switch circuit in accordance with the secondary control signal.

6. Control apparatus as claimed in claim 1 in which at least two output means are provided, and preferably, at least two switch circuits are provided, each switch circuit being operably coupled to the control means and being coupled between a corresponding one of the output means and the input means, so that the output means are operable independently of each other, and advantageously, at least two second monitoring means are provided, each second monitoring means being provided for monitoring the current being drawn through a corresponding one of the output means.

7. Control apparatus as claimed in claim 6 in which the control means is responsive to the operational status of the electrical load coupled to one of the output means being abnormal for operating the switch circuit corresponding to the output means to which the electrical load of the abnormal status is coupled for isolating the output means from the input means, and for operating the switch circuit corresponding to the other or a predetermined other one of the others of the output means for coupling the other or the predetermined other one of the output means to the input means for applying the electrical power supply to an electrical load coupled to the said other or other one of the output means.

8. Control apparatus as claimed in claim 1 in which the control apparatus is provided as a single integral unit comprising a housing defining a hollow interior region, the control means, the communicating means, the electrical power source, the first mounting means, each second mounting means and each switch circuit being located in the hollow interior region of the housing.

9. Control apparatus as claimed in claim 8 in which at least one of the output means is located in the hollow interior region of the housing and is accessible therethrough, and preferably, each output means is located in the hollow interior region of the housing and is accessible therethrough.

10. Control apparatus as claimed in claim 8 in which at least one of the output means comprises an electrical socket adapted for receiving an electrical plug top, and preferably, each electrical socket is integrally formed in the housing.

11. Control apparatus as claimed in claim 8 in which each output means comprises an electrical socket adapted for receiving an electrical plug top.

12. Control apparatus as claimed in claim 8 in which at least one of the output means comprises an output electrical terminal block for hardwiring an electrical load thereto, and preferably, each output terminal block is located within the hollow interior region of the housing, and advantageously, each output means comprises an electrical terminal block.

13. Control apparatus as claimed in claim 8 in which the input means comprises an electrical plug adapted for engaging an electrical socket, and preferably, the electrical plug is integrally formed with the housing, and alternatively, the electrical plug is located on a cable extending from the housing, and alternatively, the input means comprises an input electrical terminal block adapted for hardwiring to the electrical power supply, and preferably, the input terminal block is located in the hollow interior region of the housing.

14. Control apparatus as claimed in claim 1 in which the control means comprises a programmable microcontroller.

15. Control apparatus as claimed in claim 1 in which the communicating means comprises a communications circuit adapted for communicating with a cellular telecommunications network, and preferably, the communications circuit comprises a messaging interface, and preferably, the messaging interface is a GSM interface, and advantageously, the communications circuit comprises SIM card technology.

16. Control apparatus as claimed in claim 1 in which the communicating means monitors the strength of the coverage of a telecommunications network in which it is to communicate, and outputs a signal which is readable by the control means and is indicative of the strength of the coverage of the telecommunications network, and preferably, a means responsive to the control means is provided for outputting a representation of the signal indicative of the strength of the coverage of the telecommunications network which is perceptible to a human.

17. Control apparatus as claimed in claim 1 in which the electrical power source comprises a battery, and preferably, the battery is a rechargeable battery, and advantageously, the electrical power source comprises a battery charging circuit, and preferably, the battery charging circuit is coupled to the input means for applying the electrical power supply to the battery charging circuit.

18. Control apparatus as claimed in claim 1 in which a third monitoring means is provided for monitoring a parameter external of the control apparatus, and for applying a third output signal to the control means indicative of the status of the parameter being monitored, and preferably, the third monitoring means is adapted for monitoring a parameter of an environment external to the control apparatus, and advantageously, the third monitoring means is adapted for monitoring ambient temperature, and preferably, the third monitoring means is adapted for monitoring ambient humidity, and advantageously, the third monitoring means is adapted for monitoring the light level in the external environment.

19. Control apparatus as claimed in claim 18 in which the control means is responsive to the third output signal being indicative of the status of the parameter being monitored being abnormal for operating the communicating means to transmit a status message indicative of the status of the parameter, and preferably, the control means is responsive to the third output signal being indicative of the light level passing through a predetermined level for operating the switch circuit corresponding to at least one of the output means for coupling or isolating the corresponding output means to or from the input means, and advantageously, an input/output means is provided for inputting a status signal from a device external to the control apparatus, and the control means is responsive to the state of the status signal being indicative of an abnormal condition for operating the communicating means to transmit a status message indicative of the state of the status signal to the remote communications device, and preferably, the control means is responsive to the state of the status signal from the external device for operating the switch circuit of at least one of the output means for coupling or isolating the output means to or from the input means.

20. A method for selectively applying an electrical power supply to an electrical load, in response to a remotely generated control signal, the method comprising the steps of:
providing a control apparatus for selectively applying the electrical power supply to the electrical load,
providing the control apparatus with an input means for coupling to the electrical power supply,
providing the control apparatus with an output means for coupling to the electrical load,
providing the control apparatus with a bi-state switch circuit coupled between the input means and the output means for selectively coupling the output means to the input means for applying the electrical power supply to the electrical load,
providing the control apparatus with a first monitoring means for monitoring the presence of an electrical power supply on the input means and for producing a first output signal indicative of the presence of an electrical power supply,
providing the control apparatus with a second monitoring means for monitoring the current being drawn through the output means by the electrical load and for producing a second output signal indicative of the current being drawn through the output means,
providing the control apparatus with a communicating means for communicating the control apparatus with a remote communications device via a telecommunications network for receiving the remotely generated control signal from the remote communications device,
providing the control apparatus with a control means operably coupled to the switch circuit for selectively coupling the output means to the input means in response to the remotely generated control signal received from the remote communications device via the communicating means, the control means being responsive to the first and second output signals from the first and second monitoring means and the state of the switch circuit for determining the operational status of the electrical load, and the control means being responsive to the operational status of the electrical load being abnormal for operating the communicating means for transmitting a status message indicative of the operational status of the electrical load to the remote communications device,
providing the control apparatus with an electrical power source for powering the control means and the communicating means independently of the electrical power supply coupled to the input means, so that communication may be established between the control means and the remote communications device for controlling the control apparatus in the absence of an electrical power supply on the input means, and
transmitting the control signal from the remote communications device to the control apparatus for operating the control means to control the switch circuit for selectively coupling the output means with the input means.
